(19) United States
(12) Patent Application Publication
(10) Pub. No.: US 2007/0005594 A1
(43) Pub. Date: Jan. 4, 2007

(54) Secure keyword search system and method

(76) Inventors: Binyamin Pinkas, Tel Avlv (IL); Michael Freedman, Stanford, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/171,994

(22) Filed: Jun. 30, 2005

(51) Int. Cl. G06F 17/30

(52) U.S. Cl. 707/6

(57) ABSTRACT

A system and method for confidentially keyword searching information residing in a remote server processing system are disclosed. Briefly described, one embodiment is a method comprising receiving from a client system a keyword search request having at least one searchword; mapping a plurality of items to at least one of L bins using a function (H), the items residing in a dataset and comprised of item pairs (xi, pi), such that the item pairs are mapped to the bin H(xi); for the bins, defining at least one polynomial as a function of the items mapped into the bins; evaluating at least one of the polynomials at the searchword using an oblivious polynomial evaluation (OPE) protocol; and determining presence of at least one match between the searchword and one of the xi based upon the evaluation.

### TECHNICAL FIELD

The present invention is generally related to information exchange and, more particularly, is related to a system and method for confidential database information exchange.

### BACKGROUND

A keyword search (KS) is a fundamental database operation. A KS involves two main parties: a server, holding a database comprised of a set of records and their associated keywords, and a client, who may send queries consisting of keywords and receive the records associated with these keywords. A private or confidential KS protocol enables keyword queries while providing privacy for both parties. Queries are confidential from a client privacy perspective since queries from the database are hidden. Queries are further confidential from a server privacy perspective since the clients are prevented from learning anything but the results of the queries.

However, private keyword-search problems may arise and be defined by the following functionality. The database consists of n pairs {(x1, p1), . . . ,(xn, pn)}. For convenience, “xi” is denoted as the keyword and “pi” as the payload (database record). A query from a client is a searchword, denoted as “w” herein. The client obtains the result pi if there is a value i for which xi=w, and obtains a special symbol (for example, “#”) otherwise. Given that KS allows clients to input an arbitrary searchword, as opposed to selecting pi by an index i, a keyword search is strictly stronger than the better-studied problems of oblivious transfer (OT), private information retrieval (PIR), and symmetrically private information retrieval (SPIR).

Keyword searching is useful in scenarios in which one party holds sensitive data which it does not want to fully share with other parties, yet it is willing to answer queries about the contents of the database. Furthermore, the contents of the queries should remain hidden from the database owner. A KS is particularly attractive whenever the database items are associated with keys, such as names or id numbers, and the retrieval queries are answered based on these keys. For example, consider a scenario where the database contains information related to ten thousand phone numbers, which are obviously taken from a large domain which roughly contains all 10ˆ10 options for 10 digit phone numbers. Some KS protocols completely hide the identity of the phone numbers in the database, while having an overhead which is roughly proportional to 10,000 (and not to 10ˆ10).

A semi-private KS protocol is a KS protocol which protects the privacy of the client (i.e. does not disclose the searchword to the server), but does not necessarily preserve the privacy of the server (i.e. it might reveal to the client more about the database than merely the result of the query). A semi-private KS protocol is weaker than KS, which protects the privacy of both client and server. The work of Kushilevitz and Ostrovsky (Eyal Kushilevitz and Rafail Ostrovsky. “Replication is not needed: Single Database, Computationally-Private Information Retrieval.” In Proc. 38th Annual Symposium on Foundations of Computer Science [1], pages 364-373) described how to use PIR together with a hash function for obtaining a semi-private KS protocol. Chor et al. (Benny Chor, Niv Gilboa, and Moni Naor. “Private Information Retrieval by Keywords.” Technical Report TR-CS0917, Department of Computer Science, Technion, 1997.) described how to implement semi-private KS using PIR and any data structure supporting keyword queries, and they added server privacy using a trie data structure and many rounds.

Ogata and Kurosawa (Wakaha Ogata and Kaoru Kurosawa. “Oblivious Keyword Search.” Cryptology ePrint Archive, Report 2002/182, 2002. http://eprint.iacr.org/) show an ad-hoc solution for KS for adaptive queries, using a setup stage with linear communication. The security of their main construction is based on the random oracle assumption and on a non-standard assumption (related to the security of blind signatures). The system requires a public-key operation per item for every new query.

A problem somewhat related to KS is that of “search on encrypted data” (see Dawn Xiaodong Song, David Wagner, and Adrian Perrig. “Practical Techniques for Searches on Encrypted Data.” In IEEE Symposium on Security and Privacy, pages 44-55, 15-18 May 2000 and D. Boneh, G. Di Crescenzo, R. Ostrovsky, and G. Persiano, “Public Key Encryption with Keyword Search,” proceedings of Eurocrypt 2004, LNCS 3027, pp. 506-522, 2004). The above-identified reference involves a first party encrypting data and providing the encrypted data to a second party. This second party is later given a trapdoor key, enabling it to search the encrypted data for specific keywords, while hiding from it any other information about the data. This problem is relatively easy to solve since the search is initiated by the first party which previously encrypted the data. Furthermore, there are protocols for “search on encrypted data” (e.g., those of Song et. al. cited above) which use only symmetric-key crypto. Therefore, it is unlikely that they can be used for implementing KS, as KS implies OT and it is known that it is highly unlikely that there is a “black-box” construction of OT using symmetric-key crypto.

Another related problem is that of “secure set intersection” (described in copending patent application entitled “SYSTEM AND METHOD FOR PRIVATE INFORMATION MATCHING,” having Ser. No. 11/117,765, and incorporated herein by reference), where two parties whose inputs consist of sets X, Y privately compute the intersection of two sets X and Y. Prior art solutions are not computationally efficient.

### SUMMARY

A system and method for confidentially keyword searching information residing in a remote server processing system are disclosed. Briefly described, one embodiment is a method comprising receiving from a client system a keyword search request having at least one searchword; mapping a plurality of items to at least one of L bins using a function (H), the items residing in a dataset and comprised of item pairs (xi, pi), such that the item pairs are mapped to the bin H(xi); for the bins, defining at least one polynomial as a function of the items mapped into the bins; evaluating at least one of the polynomials at the searchword using an oblivious polynomial evaluation (OPE) protocol; and determining presence of at least one match between the searchword and one of the xi based upon the evaluation.

Another embodiment is a system that confidentially keyword searches information, comprising a server processing system that receives a searchword from a remote client processing system, a memory residing in the server processing system, a dataset residing in the memory, the dataset, a list of item pairs (xi, pi), and a processor residing in the server processing system, the processor configured to: receive from a client system a keyword search request having at least one searchword; map a plurality of items to at least one of L bins using a function (H), the items residing in a dataset and comprised of item pairs (xi, pi), such that the item pairs are mapped to the bin H(xi); for the bins, define at least one polynomial as a function of the items mapped into the bins; evaluate at least one of the polynomials at the searchword using an oblivious polynomial evaluation (OPE) protocol; and determine presence of at least one match between the searchword and one of the xi based upon the evaluation.

### BRIEF DESCRIPTION OF THE DRAWINGS

The components in the drawings are not necessarily to scale relative to each other. Like reference numerals designate corresponding parts throughout the several views.

FIG. 1 is a block diagram of an embodiment of a keyword search system.

FIG. 2 is a simplified conceptual block diagram of an embodiment illustrating a plurality of bins used for processing information of the keys of FIG. 1.

FIGS. 3 and 4 are flowcharts illustrating embodiments of a process for confidentially performing a keyword search of a database residing in the server processing system of FIG. 1.

### DETAILED DESCRIPTION

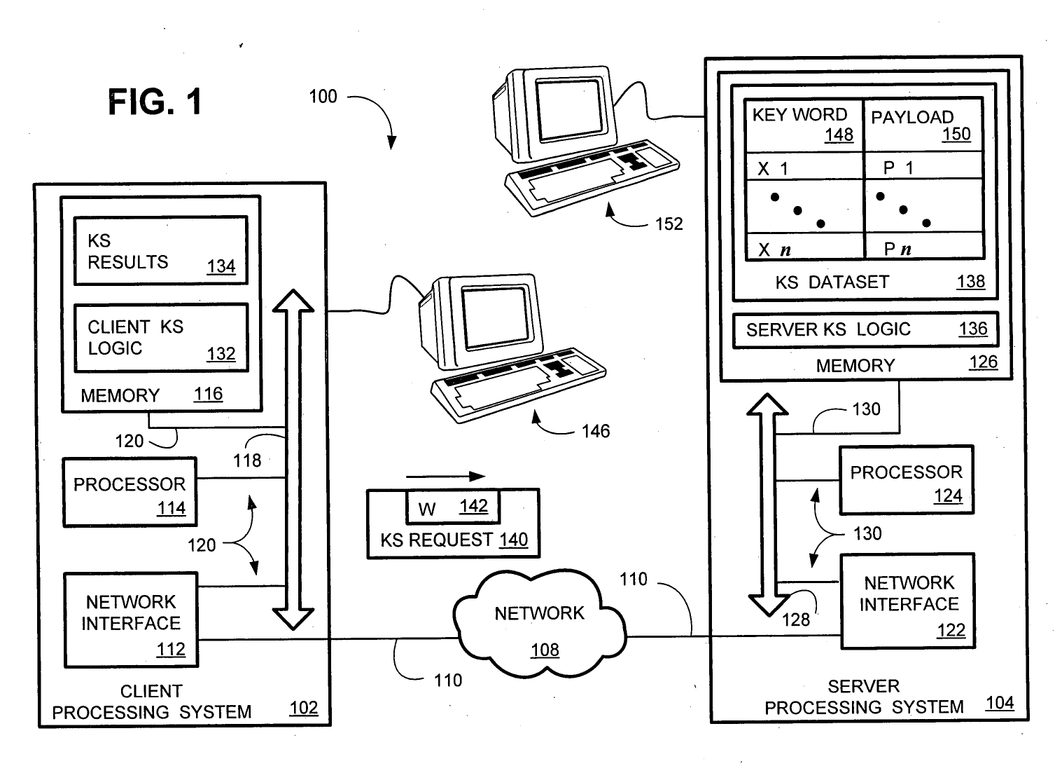

Embodiments provide a set of specific protocols for a keyword search (KS) while providing privacy for both parties. The various embodiments provide privacy, or security, based on the use of oblivious polynomial evaluation and homomorphic encryption. That is, the protocols of the various embodiments of the keyword search system 100 (FIG. 1) enables one or more remote client processing systems 102 to request a keyword search, based upon at least one specified keyword, from a server processing system 104 having a keyword search (KS) database, without receiving and/or disclosing any additional information not pertaining to the specified keywords.

Compared to above-described prior art systems, the various embodiments have several advantages. The embodiments provide privacy for both parties; have a sub-linear communication overhead; use high-degree polynomials; and encode the payload in the polynomial. Accordingly, the embodiments provide better security over prior art systems.

The exemplary embodiment illustrated in FIG. 1 comprises a client processing system 102 and a server processing system 104. The systems 102 and 104 communicate with each other through a suitable network 108, via network connections 110. The client processing system 102 comprises at least a network interface 112, a processor 114 and a memory 116. The network interface 112, processor 114 and memory 116 are communicatively coupled together over a communication bus 118, via connections 120. The server processing system 104 comprises at least a network interface 122, a processor 124 and a memory 126. Network interface 122, processor 124 and memory 126 are communicatively coupled together over a communication bus 128, via connections 130. The hardware of other embodiments may be configured differently than the systems 102, 104 illustrated in FIG. 1, and may include other components.

With respect to the client processing system 102, the client keyword search (KS) logic 132 and the KS results 134 reside in memory 116. With respect to the server processing system 104, the server keyword search (KS) logic 136 and the KS dataset 138 reside in memory 126. For convenience, logic 132 and KS results 134 are illustrated as residing in a single memory 116, and logic 136 and KS dataset 138 are illustrated as residing in the single memory 126. In other embodiments, the above described logic and/or information may reside separately in other suitable memory media.

Embodiments are configured to receive a keyword search (KS) request 140 from the client processing system 102 for a keyword search. The KS request 140 contains at least one specified searchword (w) 142. The KS request 140 is generated when the executing client KS logic 132 receives information from terminal 146 which includes at least the specified searchword 142. The KS request 140 may also include additional information, such as, but not limited to, information indicating the location and/or identification of the server processing system 104, and/or identification of the KS dataset 138, or other relevant information. The generated KS request 140 is communicated to the server processing system 104 through the network interfaces 112, 122 and the network 108.

Upon receipt of the KS request 140, the executing server KS logic 136 extracts the specified searchword 142 and begins the process of performing the keyword search in accordance with the various embodiments described herein.

The KS dataset 138 comprises a list of items, the items being in pairs {(x1, p1), . . . ,(xn, pn)} of information. For convenience, “xi” is denoted as the keyword and “pi” as the payload (database record). Thus, each item having at least two portions, a keyword 148 and a payload 150. Keyword 148 comprises one or more terms, or keywords, that have some logical relationship to information of the payload 150. For example, one of the terms of the keyword 148 may be a name, date and/or location. Descriptive terms, or keywords, corresponding to the content of the payload 150 may be used. Any suitable number of terms may be used. Terms may also be in the form of phrases. Furthermore, a plurality of some (or all) of the item pairs (xi, pi) may have a common xi and/or pi.

The payload 150 comprises information of interest. Any suitable information may reside in payload 150. Any suitable keyword, or plurality of keywords, may be a term or phrase imparting information relating to the contents of its respective payload 150. The dataset 138 may be generated by an individual entering the information through terminal 152, or may be communicated to the server processing system 104 from another device.

As noted above, upon receipt of the KS request 140, information corresponding to one or more searchword(s) 142 is extracted by the executing server KS logic 136. If there is a match between the extracted searchword 142 and at least one of the terms of the keyword 148, the corresponding payload 150 is extracted and communicated back to the client processing system 102. That is, the client obtains the result pi if there is a value i for which xi=w, and obtains a special symbol (for example, “#”) otherwise. These results are illustrated as residing in memory 116 as the KS results 134, although any suitable format of presenting the results of the keyword search may be used.

In contrast to prior art keyword searches, the server processing system 104 is not able to understand information pertaining to the received searchword(s) 142. That is, the communicated searchwords 142 remain private and confidential to the client processing system 102. Privacy and confidentiality is provided by the various embodiments using oblivious polynomial evaluations and homomorphic encryption techniques, hereinafter referred to as a keyword search (KS) protocol.

The KS protocols have a communication complexity which is logarithmic in the size of the domain of the keywords and polylogarithmic in the number of records, and require only one round of interaction, even in the case of malicious clients. All previous fully-private KS protocols either require a linear amount of communication or multiple rounds of interaction, even in the semi-honest model.

Various embodiments provide secure computation, referred to herein as privacy preserving computation. In the two-party case, two parties with private inputs may wish to compute some function of their inputs while revealing no other information about themselves. Namely, the process, or distributed protocol, of computing the function should not reveal any intermediate results to either of the parties, but rather, reveal only the final output of the function. In one embodiment, this final output is provided only to the client processing system 102.

An exemplary embodiment may be modelled in the following conceptual way: consider an “ideal” scenario where, in addition to the two parties, there exists a trusted third party (TTP). The two parties can send their inputs to the TTP. The TTP can then compute the desired function and send the result to the parties. In this case, it is clear that the parties learn nothing but the final output of the function because the TTP performs all intermediate processing. Various embodiments adhere to the same property for the secure computation protocol (i.e., not revealing more information than is revealed by the TTP), while involving only the two parties alone, with no additional TTP.

Embodiments of a KS protocol are denoted as “semi-private” if they do not ensure privacy for the server processing system 104, but rather, only for the client processing system 102. Other embodiments are fully private and provide privacy for both parties.

As noted above, there exists a problem of “secure set intersection” (described in copending patent application entitled “SYSTEM AND METHOD FOR PRIVATE INFORMATION MATCHING,” having Set. No. 11/117,765, and incorporated herein by reference), where two parties whose inputs consist of sets X, Y privately compute the intersection of two sets X and Y. Here, a keyword search, KS, is a special case of this problem with |X|=1. The specific KS protocol embodiments described herein are more efficient than applying intersection protocols to this special case. On the other hand, private set intersection can be computed by various embodiments using a KS protocol by running a KS invocation for every item in X. Accordingly, embodiments obtain efficient solutions to the set-intersection problem.

Embodiments use suitable cryptographic primitives that can be defined as instances of private two-party computation between a server and a client, including oblivious transfer (OT), single-server private information retrieval (PIR), symmetrically-private information retrieval (SPIR), and oblivious polynomial evaluation (OPE). In particular, OT, PIR and SPIR protocols may solve the following problem: a server holds a dataset 138 (FIG. 1) with entries numbered 1 to n. A client, operating client processing system 102, wishes to retrieve the payload entry in location j. The protocols let the client processing system 102 retrieve this payload entry while hiding j from the server processing system 104. OT and SPIR protocol embodiments also ensure that the rest of the dataset 138 remains hidden from the client processing system 102.

Some specific constructions for non-adaptive KS require a semantically-secure homomorphic encryption system. An exemplary semantically-secure homomorphic encryption system is described, for example, in Pascal Paillier, Public-Key Cryptosystems Based on Composite Degree Residuosity Classes, Proceedings of Eurocrypt 1999, pp 223-238, incorporated herein by reference.

A private keyword search system 100 is comprised of a server processing system 104 (S) and a client processing system 102 (C). The server's input is a dataset 138 (X) of n pairs (xi, pi), each consisting a keyword 148 (xi) and a payload 150 (pi). As noted above, keyword 148 may have one or more terms. Keywords may also be phrases. Keywords can be strings of an arbitrary length. Payloads 150 may be padded to some fixed length and have information of interest. Generally, all xi of the n pairs are distinct (though this is not a requirement).

The client's input is a searchword (w) 142. As noted above, the client provides w to the client processing system 102 via a suitable terminal 146. In other situations, search words may be provided from other sources, such as a device or an application. If there is a pair in the dataset 138 in which the keyword is equal to the searchword (w=at least one of xi), then the output is the corresponding payload 150. Otherwise the output is a special symbol(s), such as, but not limited to, the “#” symbol.

The requirements of a private KS protocol can be divided into correctness, client privacy, and server privacy components. These properties are defined independently below, and then defined as a private KS protocol that satisfies these definitions.

Definition of correctness: If both parties are honest, then, after running the protocol on inputs (X, w), the client outputs pi such that w=xi, or “#” if no such i exists.

Definition of client's privacy (indistinguishability): For any polynomial time during machine (PPT) S′ executing the server's part, and for any inputs X, w, w′, the views that S′ sees on input X, in the case that the client uses the searchword w and the case that it uses w′, are computationally indistinguishable.

In order to show that the client does not learn from the various embodiments of the protocol more or different information than it should, the protocol is compared to the ideal implementation. In the ideal implementation, a trusted third party (TTP) gets the server processing system's 104 database X and the client processing system's 102 query w as input, and outputs the corresponding payload to the client processing system 102. Privacy requires that the protocol embodiment does not leak to the client processing system 102 more information than in the ideal implementation. This is captured by the following definition.

Definition of server processing system's 104 privacy (comparison with the ideal model): For every PPT machine C′ substituting the client in the real protocol, there exists a PPT machine C″ that plays the client's role in the ideal implementation, such that on any inputs (X, w), the view of C′ is computationally indistinguishable from the output of C″. (In the semi-honest model C′=C.)

Definition of a private KS protocol: Any two-party protocol satisfying the definitions-of correctness, client processing system 102 privacy and server processing system 104 privacy.

Main Construction: KS from OPE

Oblivious Polynomial Evaluation (OPE) is a protocol involving two parties. The input of the first party is a value x in a field F, whereas the input of the second party is a polynomial P( ) defined over the same field F. At the end of the protocol the first party learns P(x) and no other information about the polynomial P( ), whereas the second party learns no information about x. There are various efficient implementations of OPE, for example based on the use of homomorphic encryption, using invocations of 1-out-of-2 OTs, or based on assumptions on the hardness of interpolating noisy polynomials. The overhead of these implementations if roughly proportional to the degree of the polynomial P( ).

The description below demonstrates construction of a non-adaptive keyword search protocol embodiment using oblivious polynomial evaluation (OPE). The construction encodes the database entries in X={(x1, p1), . . . , (xn, pn)} as values of a polynomial, i.e., to define a polynomial Q such that Q(xi)=(pi). Compared to previous prior art solutions, this construction performed by embodiments of the keyword search system 100 (FIG. 1) is unique in achieving sub-linear communication overhead in a single round of communication.

The following scheme uses any suitable generic OPE to build a KS protocol. An exemplary implementation of an embodiment of a keyword search system 100 employing the OPE based on homomorphic encryption is shown below.

### An Exemplary Protocol Embodiment 1 (Generic Polynomial-Based KS)

The input is provided by the client processing system 102 as an evaluation point w, the searchword. The server processing system 104 has a dataset 138 (FIG. 1) of interest, denoted as {(x1, p1), . . . , (xn, pn)}, where all keyword values xi are distinct. The desired output to the client processing system 102 is the payload, pi, if w=xi. Otherwise, the client processing system 102 receives nothing (or a suitable indicator indicating nothing, such as, but not limited to the “#” symbol).

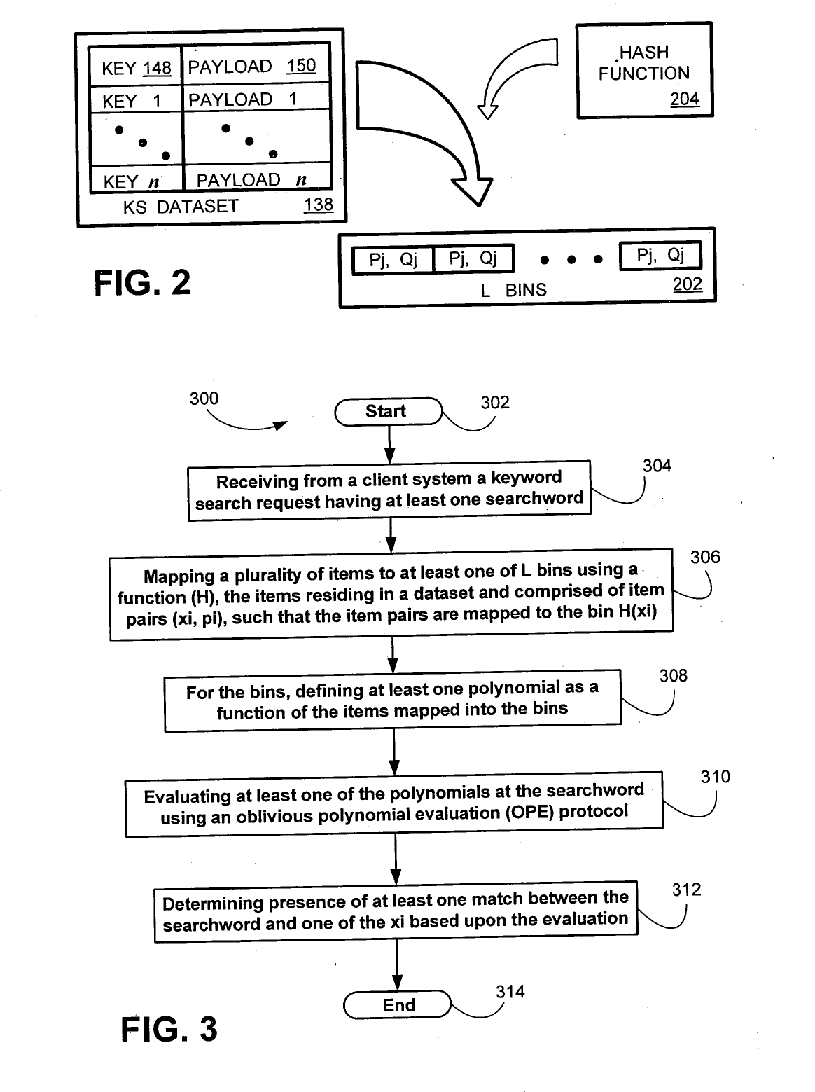

FIG. 2 is a simplified conceptual block diagram of an embodiment illustrating a plurality of bins 202 used for processing information of the keys 148 (FIG. 1). The process described below is for an exemplary embodiment.

1. The server processing system 104 defines L bins 202 and maps the n items into the L bins 202 using a random, publicly-known hash function H 204 with a range of size L. The value of L is a parameter which can take any value greater than or equal to 1 (the exact value affects the efficiency of the system, as is described below). H is applied to the dataset's keywords 148. That is, the list items (xi, pi) are mapped to bin H(xi). (If L=1 then there is a single bin and all list items are mapped to it.) Let m be a bound such that, with high probability, at most m items are mapped to any single bin 202. (At this point, L and m are parameters.)

2. For every bin j, the server processing system 104 defines two polynomials Pj and Qj of degree which is equal to the number of items mapped to the bin minus 1 (and is at most m−1). The polynomials are defined such that for every pair (xi, pi), the item pairs are mapped to bin j. Accordingly, Pj(xi)=0 and Qj(xi)=(pi|0ˆs), where s is a statistical security parameter. Namely, Qj(xi) is equal to pi concatenated to s successive 0 bits. Alternatively, the polynomial Qj can be defined with Qj(xi) having any special property which would enable the client to identify it. For example, Qj(xi) in an alternative embodiment could end with any string of length s, known to the client. In this case, the probability that the client identifies a random value of Qj as having this property is at most 2ˆ{−s}. Another embodiment defines Qj(xi) to end with an encoding of xi. Many other options are also possible.

3. For each bin j, the server processing system 104 picks a new random value rj and defines the polynomial Z_j(w)=rj˜Pj(w)+Qj(w).

4. The two parties run an OPE protocol in which the client processing system 102 evaluates all L polynomials Z_{—}1, . . . , Z_L at the searchword w.

5. The client processing system 102 learns the result of Z_H(w)(w), i.e., of the polynomial associated with the bin H(w). If this value is of the form p|0ˆs, the client processing system 102 outputs p. Otherwise the client processing system 102 outputs #.

To instantiate this generic scheme, the following three open issues are considered: (1) the OPE method used by the parties, (2) the number of bins L, and (3) the method by which the client processing system 102 receives the OPE output for the relevant bin. Additionally, a carefully-chosen hashing method to obtain a balanced allocation of items into bins may be considered for alternative embodiments.

This exemplary embodiment uses an OPE protocol. Such a protocol can be constructed based on the hardness of noisy polynomial interpolation or using log |F| invocations of 1-out-of-2 OTs, where F is the underlying field. Alternatively, another embodiment may be based on homomorphic encryption (such as Paillier's system) in the following way. First, a single database bin is introduced.

The server processing system's 104 input is a polynomial of degree m, where
P(w)=a_{—}m*wˆm+ . . .+a_{—}1*w+a_{—}0.

The client processing system 102 inputs a value w.

The client processing system 102 sends to the server processing system 104 homomorphic encryptions of the powers of w up to the m'th power, i.e.,
Enc(w),Enc(wˆ2), . . . ,Enc(wˆm).

The server processing system 104 uses the homomorphic properties to compute the following value:
Enc(a_{—}m*wˆm)* . . . *Enc(a_{—}1*w)*Enc(a_{—}0)=
Enc(a_{—}m*wˆm+ . . . +a_{—}1*w+a_{—}0)=
Enc(P(w))
The server processing system 104 sends this result back to the client processing system 102.

In the case of semi-honest parties, the OPE protocol is correct and private. Furthermore, the protocol can be applied in parallel to multiple polynomials, and the structure of the protocol enforces that the client evaluates all polynomials at the same point.

Now, consider that the server processing system's 104 input is L polynomials, one per bin. The protocol's overhead for computing all polynomials is the following. The client processing system 102 computes and sends m encryptions. Every polynomial Pj used by the server processing system 104 is of degree d_j<m (where d_j+1 items are mapped to bin j), and the server processing system 104 evaluates it using dj+1 homomorphic multiplications of plaintexts. Thus, the total work of the server is (d_{—}1+1)+(d_{—}1+1)+ . . . +(d_L+1)=n exponentiations. The server processing system 104 returns just a single value for each of the L polynomials.

As an exemplary protocol embodiment, the server processing system 104 assigns the n items to a single bin (L=1). In this case the client's 102 OPE message contains n homomorphic encryptions (of the values w,wˆ2, . . . ,wˆn). The client obtains a single result, and checks it. This protocol embodiment has communication and computation overhead of O(n).

As an exemplary protocol embodiment, the server processing system 104 assigns the n items to L bins arbitrarily and evenly, ensuring that L items are assigned to every bin; thus, L=sqrt(n). The client processing system 102 need not know which items are mapped to which bin. The client's 102 message during the OPE consists of L=O(sqrt(n)) homomorphic encryptions. The server processing system 104 evaluates L polynomials by performing n homomorphic multiplications (exponentiations), and replies with the L=sqrt(n) results. This protocol embodiment has a communication overhead of O(sqrt(n)), O(n) computation overhead at the server's side, and O(sqrt(n)) computation overhead at the client's side.

Embodiments receiving the OPE output may reduce communication overhead using private information retrieval (PIR). In this exemplary embodiment, the client processing system 102 does not need to learn the outputs of all polynomials, but rather, only the value of the polynomial associated with the bin to which w might be mapped. To further lower the communication complexity, the protocol embodiment uses a public hash-function H 204 (FIG. 2) and invokes PIR to retrieve the result of the relevant polynomial evaluation. That is, the function H 204 is chosen independently of the content of the database, and it is used to map items to bins 202. After the server processing system 104 (FIG. 1) evaluates the L polynomials on the client processing system's 102 input w, the client processing system 102 runs a 1-out-of-L PIR scheme to learn the result of the polynomial of bin H(w).

The total communication overhead is O(m), which is, approximately, n/L (client to server.) plus the overhead of the PIR scheme. One embodiment uses a PIR scheme with a polylogarithmic communication overhead, such as the scheme of Cachin et al. (Christian Cachin, Silvio Micali, and Markus Stadler. Computationally private information retrieval with polylogarithmic communication. Advances in Cryptology—EUROCRYPT '99, LNCS 1592, Springer-Verlag, pp. 402-414, 1999, incorporated by reference herein) based on the phi-hiding assumption or the schemes of Chang (Yan-Cheng Chang, Single database private information retrieval with logarithmic communication. In Proc. of 9th ACISP, LNCS 3108, Springer-Verlag, pp. 50-61. 2004, incorporated herein by reference) or Lipmaa (Helger Lipmaa. An oblivious transfer protocol with log-squared communication. Cryptology ePrint Archive, Report 2004/063, 2004, incorporated herein by reference) based on the Paillier and Damgard-Jurik cryptosystems, respectively. In these embodiments, setting L=n/log n gives a total communication of O(polylog n). Here, the client processing system 102 can combine the first message from its KS scheme with that of its PIR scheme. Thus, the round overhead of the combined protocol is the same as that of the PIR protocol alone; The computation overhead of the server processing system 104 is O(n) plus that of a PIR scheme with L inputs; the client processing system's 102 overhead is O(m) plus that of a PIR scheme with L inputs.

Accordingly, the following results: There exists a KS system for semi-honest parties with a communication overhead of O(polylog n) and a computation overhead of O(log n) “public-key” operations for the client and O(n) for the server. The security of the KS system is based on the assumptions used for proving the security of the KS protocol's homomorphic encryption system and of the PIR system.

Furthermore, for semi-honest parties, given a pair (xi, pi) in the server processing system's 104 input such that w=xi, it is clear that the client processing system 102 outputs pi. If w is not equal to xi for all i, the client processing system 102 outputs # with probability at least 1½ˆs. The protocol is therefore correct. Since the server processing system 104 receives semantically-secure homomorphic encryptions and the PIR protocol protects the privacy of the client, the protocol ensures the client's privacy: The server processing system 104 cannot distinguish between any two client inputs x, x′. Finally, the protocol protects the server processing system's 102 privacy: If a polynomial Z with fresh randomness is prepared for every query on every bin, then the result of the client's query w is random if w is not a root of P, i.e., if w is not in the server's input X. A party running the client's role in the ideal model can therefore simulate the client's view in the real execution.

Embodiments are configured for handling malicious servers (or a server processing system 104 that is programmed to operate in a malicious manner). Assume that the PIR protocol provides client privacy in the face of a malicious server processing system 104. Then the protocol embodiment is secure against a malicious server processing system 104 (per our definition of security), as the only information that the server processing system 104 receives, in addition to messages of the PIR protocol, is composed of semantically-secure encryptions of powers of the client's input searchword w.

Embodiments are configured for handling malicious clients (or a client processing system 102 that is programmed to operate in a malicious manner). If the client processing system 102 is malicious, then server processing system 104 privacy is not guaranteed by the protocol embodiment 1 as described above. For example, a malicious client processing system 102 could send encryptions that do not correspond to powers of a value w. However, if the OPE protocol used in the protocol embodiment 1 is secure against a malicious client processing system 102, then the overall protocol provides security against all malicious clients, regardless of the security of the PIR protocol. (Note that there are no server privacy requirements on PIR; it is used merely to reduce communication complexity.)

One embodiment therefore requires the client processing system 102 to prove that the encryptions it sends in the OPE protocol are well-formed, i.e., correspond to encryptions of a sequence of values w, wˆ2, . . . , wˆm. The drawback of using such a proof (and proving its security in the standard model) is that it requires more than a single round of messages. A more efficient embodiment is based on a reduction of the OPE of a polynomial of degree m, to m OPEs of linear polynomials. The overhead of the resulting protocol embodiment is similar to that of a direct OPE of the polynomial, and the protocol consists of only a single round (the m OPEs of the linear polynomials are done in parallel).

When the OPE protocol (based on homomorphic encryption) is applied to a linear polynomial, any encrypted value (w) sent by the client processing system 102 corresponds to a valid input to the polynomial, and thus the OPE of the linear polynomial computes a legitimate value of the polynomial. Therefore, if we ensure that the client processing system 102 sends a legitimate encryption, the obtained linear OPE (and thus a general OPE) is secure against malicious clients.

When considering concrete instantiations of the OPE protocol, an embodiment using the El Gamal cryptosystem has the required property. That is, any ciphertext can be decrypted. The El Gamal cryptosystem can therefore be used for implementing a single-round OPE secure against a malicious client. Yet, the El Gamal system has a different drawback: given that it is multiplicatively homomorphic, it can only be used for an OPE in which the receiver obtains gˆ(P(x)), rather than P(x) itself. Thus, a direct use of El Gamal in KS is only useful for short payloads, as it requires encoding the payload in the exponent and asking the receiver to compute its discrete log.

Another embodiment can slightly modify the KS protocol to use El Gamal yet still support payloads of arbitrary length. With such an embodiment, the server processing system 104 maps the items to n/log n bins as usual, but defines, for every bin j, a random polynomial Z_j of degree m=O(log n). For an item (xi, pi), the server processing system 104 encrypts pi|0ˆs using the key gˆ(Z_H(xi)(xi)). The client processing system 102 sends a first message for an El Gamal-based OPE, namely encryptions of gˆw, gˆ(wˆ2), . . . , gˆ(wˆm). The server processing system 104 then prepares, for every bin j, a message [gˆZ_j (w), Enc_(Z_j (x_(j,1)))(pj,1|0ˆs), . . . , Enc_(Z_j (x_(j,m)))(pj,m|0ˆs)], where the x_(j,i)'s (for i=1. . . m) are the messages mapped to bin j. The client processing system 102 uses PIR to learn the message of its bin of interest, and then can decrypt the payload corresponding to w if there exists an x_(j,i) which is equal to w.

The only difference of the modified protocol is that the message learned during the PIR is of size O(|pi| log n) rather than of size O(|pi|). The overall communication complexity does not change, however, since the PIR has polylogarithmic overhead. Essentially, the same overhead is obtained, including round complexity, as Protocol 1.

In various situations, multiple invocations (construction) of a keyword search is desirable. The privacy of the server processing system 104 in the above-described Protocol Embodiment 1, and its variants, is based on the fact that the client processing system 102 can evaluate each polynomial Z at most once. Therefore, fresh randomness ri must be used in order to generate new polynomials Z_1, . . . Z_L for every invocation of the protocol. Accordingly, using the protocol for multiple queries must essentially be done by independent invocations of the protocol.

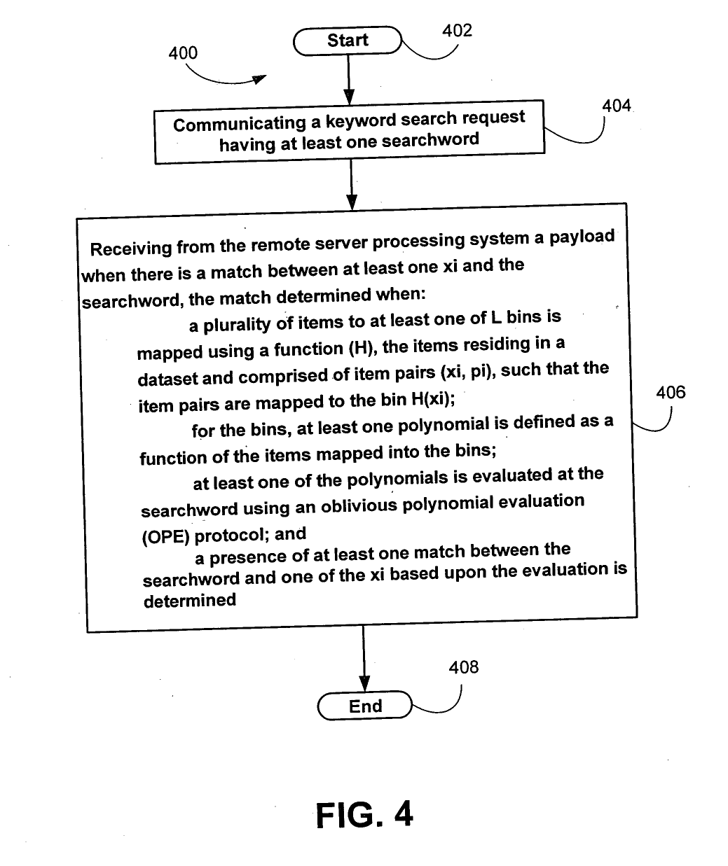

FIGS. 3 and 4 are flowcharts illustrating embodiments of a process for confidentially performing a keyword search of a dataset 138 residing in the server processing system 104 (FIG. 1). The flow charts 300 and/or 400 show the architecture, functionality, and operation of an embodiment for implementing the server KS logic 136 (FIG. 1) such that information in a payload 150, corresponding to a keyword 148 matching the searchword w is confidentially determined. Alternative embodiments may implement the logic corresponding to flow charts 300 and/or 400 with hardware configured as a state machine. In this regard, each block may represent a module, segment or portion of code, which comprises one or more executable instructions for implementing the specified logical function(s). It should also be noted that in alternative embodiments, the functions noted in the blocks may occur out of the order noted in FIGS. 3 and or 4, or may include additional functions. For example, two blocks shown in succession in FIG. 3 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure.

The process of flow chart 300 begins at block 302. At block 304, a keyword search request having at least one searchword is received from a client system. At block 306, a plurality of items are mapped to at least one of L bins using a function (H), the items residing in a dataset and comprised of item pairs (xi, pi), such that the item pairs are mapped to the bin H(xi). At block 308, for the bins, at least one polynomial is defined as a function of the items mapped into the bins. At block 310, at least one of the polynomials at the searchword is evaluated using an oblivious polynomial evaluation (OPE) protocol. At block 312, presence of at least one match is determined between the searchword and one of the xi based upon the evaluation. The process ends at block 314.

The process of flow chart 400 begins at block 402. At block 404, a keyword search request having at least one searchword is communicated. At block 406, a payload is received from the remote server processing system when there is a match between at least one xi and the searchword. The match is determined when: a plurality of items to at least one of L bins is mapped using a function (H), the items residing in a dataset and comprised of item pairs (xi, pi), such that the xi are mapped to the bin H(xi); for the bins, at least one polynomial is defined as a function of the items mapped into the bins; at least one of the polynomials is evaluated at the searchword using an oblivious polynomial evaluation (OPE) protocol; and a presence of at least one match between the searchword and one of the xi based upon the evaluation is determined. The process ends at block 408.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modification and variations are intended to be included herein within the scope of this disclosure and the present invention and protected by the following claims.

What is claimed is:

1. A method for confidentially keyword searching information residing in a remote server processing system, comprising:
receiving from a client system a keyword search request having at least one searchword;
mapping a plurality of items to at least one of L bins using a hash function (H), the items residing in a dataset and comprised of item pairs (xi, pi), such that the item pairs are mapped to the bin H(xi);
for the bins, defining at least one polynomial as a function of the items mapped into the bins;
evaluating at least one of the polynomials at the searchword using an oblivious polynomial evaluation (OPE) protocol; and
determining presence of at least one match between the searchword and one of the xi based upon the evaluation.

2. The method of claim 1, further comprising:
defining at least one polynomial Zj, such that for every xi mapped to bin j, pi is computed from Zj(xi); and
evaluating at least the polynomial Zj at the searchword.

3. The method of claim 1, further comprising:
for every bin j of the bins, defining a polynomial Pj, such that Pj(xi)=0 for every xi mapped to bin j; and
defining a polynomial Qj such that Qj(xi)=pj for every xi mapped to bin j, a random value rj is picked and at least one polynomial Zj(w)=rj·Pj(w)+Qj(w) is defined.

4. The method of claim 1, wherein information in the xi are keywords.

5. The method of claim 4, wherein information in the pi is a payload, the payload corresponding to information of interest, and wherein the xi is at least one term or phrase corresponding to the information of the payload.

6. The method of claim 1, wherein further comprising defining the L bins to which the items are mapped.

7. The method of claim 1, wherein the hash function is a random, publicly-known hash function.

8. The method of claim 1, further comprising defining a bound m such that, with high probability, at most m items are mapped to any single bin.

9. The method of claim 1, wherein the degree of at least one polynomial is equal to at least a number of items mapped to the corresponding bin minus 1.

10. The method of claim 1, wherein at a Pj(xi)=0 and Qj(xi)=(pi|0ˆs ), s is a statistical security parameter.

11. The method of claim 1, further comprising communicating information to the client system, the information corresponding to the pi associated with the xi of the determined match with the searchword.

12. The method of claim 11, wherein communicating information to the client system further comprises communicating a value of Z_H(w)(w) of the polynomial associated with the bin H(w).

13. The method of claim 1, further comprising communicating no information to the client system when there is no determined match between at least one xi and the searchword.

14. The method of claim 1, further comprising communicating information to the client system when there is no determined match between at least one xi and the searchword, the information indicating the no match determination.

15. The method of claim 1, wherein the items residing in the dataset comprise a plurality of item pairs (xi, pi), and wherein the item pairs have a common pi.

16. The method of claim 1, wherein the items residing in the dataset comprise a plurality of item pairs (xi, pi), and wherein the item pairs have a common xi.

17. A system that confidentially keyword searches information, comprising:
a server processing system that receives a searchword from a remote client system;
a memory residing in the server processing system;
a dataset residing in the memory, the dataset a list of item pairs (xi, pi); and
a processor residing in the server processing system, the processor configured to:
receive from a client system a keyword search request having at least one searchword;
map a plurality of items to at least one of L bins using a function (H), the items residing in a dataset and comprised of item pairs (xi, pi), such that the item pairs are mapped to the bin H(xi);
for the bins, define at least one polynomial as a function of the items mapped into the bins;
evaluate at least one of the polynomials at the searchword using an oblivious polynomial evaluation (OPE) protocol; and
determine presence of at least one match between the searchword and one of the xi based upon the evaluation.

18. The system of claim 16, wherein the processor:
defines at least one polynomial Zj, such that for every xi mapped to bin j, pi is computed from Zj(xi); and
evaluates at least the polynomial Zj at the searchword.

19. The system of claim 16, wherein the processor:
for every bin j of the bins, defines a polynomial Pj, such that Pj(xi)=0 for every xi mapped to bin j; and
defines a polynomial Qj such that Qj(xi)=pj for every xi mapped to bin j, a random value rj is picked and at least one polynomial Zj(w)=rj·Pj(w)+Qj(w) is defined.

20. The system of claim 16, wherein information in the xi are keywords and wherein information in the pi is a payload, the payload corresponding to information of interest, and wherein the xi is at least one term or phrase corresponding to the information of the payload.

21. The system of claim 16, wherein the server processing system communicates information to the client system corresponding to the pi associated with the xi of the determined match with the searchword.

22. The method of claim 20, wherein the communicated information to the client system further comprises communicating a value of Z_H(w)(w) of the polynomial associated with the bin H(w).

23. A program for confidentially matching information among parties stored on computer-readable medium, the program comprising logic configured to perform:
receiving from a client system a keyword search request having at least one searchword;
mapping a plurality of items to at least one of L bins using a function (H), the items residing in a dataset and comprised of item pairs (xi, pi), such that the item pairs are mapped to the bin H(xi);
for the bins, defining at least one polynomial as a function of the items mapped into the bins;
evaluating at least one of the polynomials at the searchword using an oblivious polynomial evaluation (OPE) protocol; and
determining presence of at least one match between the searchword and one of the xi based upon the evaluation.

24. A method for confidentially requesting a keyword search for information residing in a remote server processing system, comprising:
communicating a keyword search request having at least one searchword; and
receiving from the remote server processing system a payload when there is a match between at least one xi and the searchword, the match determined when:
a plurality of items to at least one of L bins is mapped using a function (H), the items residing in a dataset and comprised of item pairs (xi, pi), such that the item pairs are mapped to the bin H(xi);
for the bins, at least one polynomial is defined as a function of the items mapped into the bins;
at least one of the polynomials is evaluated at the searchword using an oblivious polynomial evaluation (OPE) protocol; and
a presence of at least one match between the searchword and one of the xi based upon the evaluation is determined.

25. The method of claim 23, wherein information in the xi are keywords and wherein information in the pi is a payload, the payload corresponding to information of interest, and wherein the xi is at least one term or phrase corresponding to the information of the payload.

26. A system for confidentially keyword searching information residing in a remote server processing system, comprising:
means for receiving from a client system a keyword search request having at least one searchword;
means for mapping a plurality of items to at least one of L bins using a function (H), the items residing in a dataset and comprised of item pairs (xi, pi), such that the item pairs are mapped to the bin H(xi);
for the bins, means for defining at least one polynomial as a function of the items mapped into the bins;
means for evaluating at least one of the polynomials at the searchword using an oblivious polynomial evaluation (OPE) protocol;
means for determining presence of at least one match between the searchword and one of the xi based upon the evaluation; and
means for communicating a response to the client system when presence of the match is determined, wherein information in the xi are keywords and wherein information in the pi is a payload, the payload corresponding to information of interest, and wherein the xi is at least one term or phrase corresponding to the information of the payload.
